(19) United States
(12) Patent Application Publication
(10) Pub. No.: US 2026/0296411 A1
(43) Pub. Date: Oct. 1, 2026

(54) SAFETY DRIVING ASSISTANCE METHOD AND SYSTEM

(71) Applicant: HYUNDAI MOBIS CO., LTD., Seoul (KR)

(72) Inventors: Hyeon KO, Yongin-si (KR); Hyung Wook So, Yongin-si (KR)

(73) Assignee: HYUNDAI MOBIS CO., LTD., Seoul (KR)

(21) Appl. No.: 19/422,780

(22) Filed: Dec. 17, 2025

(30) Foreign Application Priority Data
Mar. 25, 2025 (KR) 10-2025-0037922

(51) Int. Cl. B60W 30/09; B60W 30/12; B60W 30/14; B60W 50/00

(52) U.S. Cl. CPC B60W 30/09; B60W 30/12; B60W 30/14; B60W 50/0097; B60W 2050/0083; B60W 2520/10; B60W 2554/406; B60W 2556/40

(57) ABSTRACT

The present disclosure provides a safety driving assistance method performed by a processor, including: selecting an accident prediction section by analyzing moving vehicle data collected from a moving vehicle and accumulated over a certain period of time; receiving real-time traffic congestion section information; and changing a setting value of an advanced driver assistance system (ADAS) before entering the accident prediction section or the real-time traffic congestion section to a preset setting value.

### CROSS-REFERENCE TO RELATED APPLICATIONS

This application claims priority under 35 U.S.C. § 119 to Korean Patent Application No. 10-2025-0037922, filed on Mar. 25, 2025, in the Korean Intellectual Property Office, the disclosure of which is incorporated herein by reference in its entirety.

### TECHNICAL FIELD

The following disclosure relates to a safety driving assistance system, and more particularly, to a safety driving assistance system that provides customized safety driving assistance services in preparation for dangerous situations.

### BACKGROUND

Moving vehicles are equipped with various advanced driver assistance systems (ADAS) to help drivers drive safely. Representative ADAS functions include forward collision-avoidance assist (FCA), smart cruise control (SCC), lane keeping assist (LKA), etc. Each of these ADAS functions determines warning or control intervention timing according to its setting value, and a driver may adjust a setting value according to his or her preference or driving style.

However, the current ADAS system has a limitation in that it operates only with values set by the driver regardless of dangerous situations or traffic conditions on the road. For example, since the ADAS system operates with the same setting value as usual even in a section where accidents frequently occur or in a severe traffic congestion section, there is a problem in that the ADAS system may not respond to even case where more conservative settings are required depending on the situations.

In addition, a navigation system of a moving vehicle receives real-time traffic information and provides information on a traffic congestion section or accident-prone section to a driver, but since this information is not linked to the ADAS function, the driver faces the inconvenience of having to manually change ADAS settings. In particular, changing the ADAS settings while driving may distract the driver's concentration, which may actually pose a risk to safety.

In addition, although technology has been developed to collect various driving data (acceleration, braking, lane changes, etc.) generated by a moving vehicle, there are very few cases where such data has been analyzed and implemented into services that actually contribute to safe driving.

On the other hand, even if a driver wants to manually change the settings of the ADAS function when the moving vehicle enters the accident-risk section or the traffic congestion section, there is a problem that it is difficult to do the operation immediately while driving. In addition, when the driver manually changes the settings of the ADAS function while driving, it is possible to increase the risk of an accident by distracting the driver's attention.

Therefore, a safety driving assistance system that links accident prediction section information obtained by analyzing driving data of a moving vehicle and real-time traffic congestion section information of navigation with an ADAS function is required.

### RELATED ART DOCUMENT

### Patent Document

Korean Patent No. 10-2459614

### SUMMARY

An embodiment of the present disclosure is directed to providing a safety driving assistance method and system that effectively support safe driving of a driver by linking accident-prone area and real-time traffic congestion section information derived through analysis of driving data of a moving vehicle with ADAS to automatically change an ADAS setting value to a safer value when entering the corresponding section.

In one general aspect, a safety driving assistance method performed by a processor includes: selecting an accident prediction section by analyzing moving vehicle data collected and accumulated from a moving vehicle; receiving real-time traffic congestion section information; and changing a setting value of an advanced driver assistance system (ADAS) before entering the accident prediction section or the real-time traffic congestion section to a preset setting value.

The moving vehicle data may include at least one of a speed, acceleration, forward collision warning information, emergency braking occurrence information, location information, moving vehicle collision information, and airbag collision detection information of the moving vehicle.

In the selecting of the accident prediction section, a section including moving vehicle data corresponding to a preset abnormal data selection criterion a certain number of times or more may be selected as the accident prediction section.

In the selecting of the accident prediction section, the selected accident prediction section may match a navigation map installed in the moving vehicle.

In the receiving of the real-time traffic congestion section information, information on a currently driving section may be received, and the driving section information may include the real-time traffic congestion section information.

The changing may include determining whether the moving vehicle reaches a first point that is a predetermined distance ahead of the accident prediction section or a traffic congestion section start point and a second point that is a predetermined distance away from the accident prediction section or a traffic congestion section end point, by using the driving section information received from the navigation and a current speed of the moving vehicle.

The changing may include: when the moving vehicle reaches the first point, receiving approval from a driver to change the setting value of the ADAS to a preset setting value; and when the driver approves the change of the setting value of the ADAS, changing the setting value of the ADAS to the preset setting value, and when the driver does not approve the change of the setting value of the ADAS, maintaining an current setting value.

The changing may include, when the moving vehicle reaches the second point, restoring the setting value of the ADAS to a setting value before the setting value of the ADAS is changed.

The setting value of the ADAS may be a setting value for at least one of smart cruise control (SCC), forward collision-avoidance assist (FCA), and lane keeping assist (LKA).

In another general aspect, a safety driving assistance system includes: an accident prediction section selection unit that analyzes moving vehicle data collected from a moving vehicle to select an accident prediction section; a traffic congestion information receiving unit that receives real-time traffic congestion section information; and a control unit that changes a setting value of an advanced driver assistance system (ADAS) before entering the accident prediction section or the real-time traffic congestion section to a preset setting value.

### BRIEF DESCRIPTION OF THE DRAWINGS

FIG. 1 is a flowchart of a safety driving assistance method according to an embodiment of the present disclosure.

FIG. 2 is an overall flowchart of the safety driving assistance method according to an embodiment of the present disclosure.

FIG. 3 is a flowchart of a step of selecting an accident prediction section according to an embodiment of the present disclosure.

FIG. 4 is a flowchart of a step of receiving traffic congestion section information according to an embodiment of the present disclosure.

FIG. 5 is a flowchart of a step of changing a setting value according to an embodiment of the present disclosure.

FIG. 6 is a flowchart of a safety driving assistance system according to an embodiment of the present disclosure.

### DETAILED DESCRIPTION OF MAIN ELEMENTS

100: Safety driving assistance system
110: Accident prediction section selection unit
130: Traffic congestion information receiving unit
150: Control unit

### DETAILED DESCRIPTION OF EMBODIMENTS

Hereinafter, the present disclosure will be described in detail with reference to the contents described in the accompanying drawings. However, the present disclosure will be not limited or restricted to exemplary the embodiments. Throughout the accompanying drawings, like reference numerals denote members performing substantially the same functions.

The object and effect of the present disclosure may be naturally understood or made clearer by the following description, and the object and effect of the present disclosure are not limited to the following description alone. Further, in describing the present disclosure, in the case in which it is decided that a detailed description of a well-known technology associated with the present disclosure may unnecessarily make the gist of the present disclosure unclear, it will be omitted.

The terms as used herein are used only in order to describe specific embodiments rather than limiting the present disclosure. Singular expressions are intended to include plural expressions unless the context clearly indicates otherwise. It will be understood that the terms “includes” or “have” used in this application, specify the presence of stated features, numerals, steps, operations, components, parts mentioned in the present disclosure, or a combination thereof, but do not preclude the presence or addition of one or more other features, numerals, steps, operations, components, parts, or a combination thereof.

Unless indicated otherwise, all the terms used in the present specification, including technical and scientific terms, have the same meanings as meanings that are generally understood by those skilled in the art to which the present disclosure pertains. Terms generally used and defined in a dictionary are to be interpreted as the same meanings with meanings within the context of the related art, and are not to be interpreted as ideal or excessively formal meanings unless clearly indicated in the present disclosure.

When interpreting a component, it is interpreted as including the error range even if there is no separate explicit description. When describing a temporal relationship, for example, when the temporal continuity is described as ‘~after’, ‘~following’, ‘~next to’, ‘~before’, etc., it also includes cases where it is not continuous, unless ‘right away’ or ‘directly’ is used.

Hereinafter, technical configurations of the present disclosure will be described in detail with reference to the accompanying drawings.

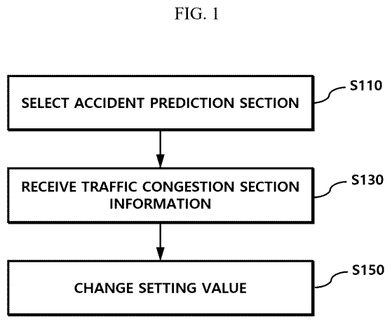

FIG. 1 is a flowchart of a safety driving assistance method according to an embodiment of the present disclosure. Referring to FIG. 1, the safety driving assistance method may include a step (S110) of selecting an accident prediction section, a step (S130) of receiving real-time traffic congestion section information, and a step (S150) of changing.

The safety driving assistance method may be performed by a processor. The processor may be configured with one or more cores, and may include a processor for data analysis, such as a central processing unit (CPU), a general purpose graphics processing unit (GPGPU), or a tensor processing unit (TPU) of a computing device.

When a driver changes advanced driver assistance system (ADAS) function settings before entering an accident prediction section or a traffic congestion section, the safety driving assistance method may perform the change immediately. The safety driving assistance method may link an accident prediction section or a traffic congestion section notification function with a moving vehicle ADAS function.

The safety driving assistance method may prepare for dangerous situations without the driver's active intervention by automatically changing a setting value of the ADAS function to safer values before entering the accident prediction section and traffic congestion section. In addition, the safety driving assistance method may prevent a driver from reducing his/her driving concentration by eliminating the inconvenience of having to change the ADAS setting directly while driving, thereby enhancing the accident prevention effect. The safety driving assistance method may link the accident prediction section information derived by analyzing the accumulated data of the moving vehicle and the real-time traffic congestion section information of the navigation with the ADAS, thereby assisting the data-based safe driving.

The ADAS mentioned throughout this specification may mean a system that assists safe driving by recognizing surrounding situations through various sensors and cameras installed in a moving vehicle, detecting potential hazards, and providing a warning to a driver or directly controlling a moving vehicle. Here, the sensor may include a radar, a lidar, an ultrasonic sensor, an infrared sensor, etc., and the camera may include a monocular/multi-lens camera, an infrared camera, a stereo camera, etc. The information collected through the sensor and camera may be processed in an electronic control unit (ECU) of the moving vehicle and utilized to implement various safety functions.

The main functions of the ADAS include, but are not limited to, forward collision-avoidance assist (FCA), lane keeping assist (LKA), smart cruise control (SCC), blind-spot collision-avoidance assist (BCA), and driver attention warning (DAW), etc. Each ADAS function may determine warning occurrence and control intervention timing based on preset criteria or values set by the driver. For example, in the case of the FCA, the warning timing may be set to ‘normal’ or ‘slow’, in the case of the SCC, a distance from the preceding moving vehicle may be set to levels 1 to 4, and in the case of the LKA, a lane departure determination criterion may be adjusted.

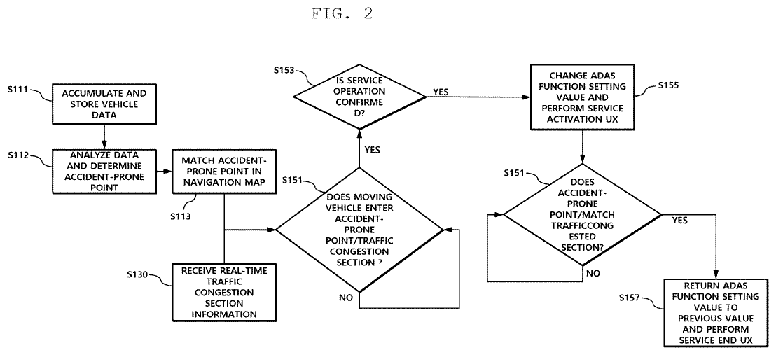

These ADAS functions may operate individually or may be integrated and interconnected. In addition, the ADAS may operate by linking to other systems of the moving vehicle, such as an electronic control device of the moving vehicle, as well as a navigation system and a communication system, thereby providing more advanced safe driving assistance functions. The implementation method of ADAS may continue to evolve with the development of hardware and software, and the ADAS mentioned in the present disclosure is not limited to the currently known implementation method and includes all types of driver assistance systems that may be developed in the future. FIG. 2 is an overall flowchart of the safety driving assistance method according to an embodiment of the present disclosure. Referring to FIG. 2, the safety driving assistance method may largely include a step (S110) of selecting an accident prediction section, a step (S130) of receiving real-time traffic congestion section information, and a step (S150) of changing. The step (S110) of selecting the accident prediction section may analyze accumulated stored vehicle data to determine an accident-prone point and match the accident-prone point to a navigation map (S111 to S113). The step (S150) of changing may change the ADAS function setting value by receiving confirmation from the driver when entering the accident-prone point/traffic congestion section, and may return to a previous ADAS function setting value when the accident-prone point/traffic congestion section ends (S151 to S157).

The specific contents of each step will be described in detail below.

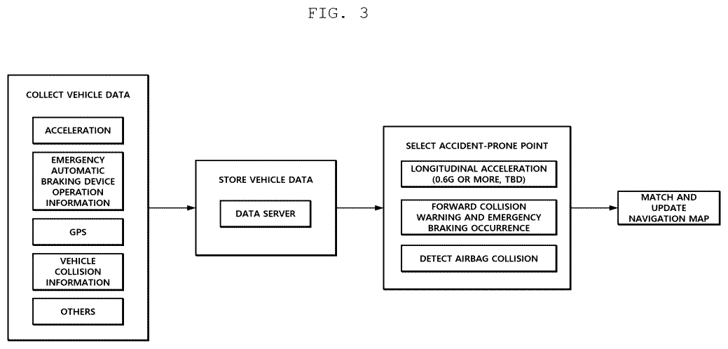

FIG. 3 illustrates a flowchart of a step (S110) of selecting an accident prediction section according to an embodiment of the present disclosure. Referring to FIG. 3, the step (S110) of selecting the accident prediction section may analyze the moving vehicle data collected from a moving vehicle and accumulated for a certain period of time to select the accident prediction section. Specifically, the step (S110) of selecting the accident prediction section may include collecting and storing the moving vehicle data (S111), selecting the accident prediction section according to preset criteria (S112), and matching the selected accident prediction section to the navigation map (S113).

The moving vehicle data mentioned in the present disclosure may mean all types of data collected in relation to the driving of the moving vehicle. The moving vehicle data may be collected through various sensors, electronic control units (ECUs), ADASs, etc., mounted on the moving vehicle, and may be generated in real time and processed within the moving vehicle or transmitted to an external server via wireless communication. Specifically, the moving vehicle data may include, but is not limited to, basic data (such as the moving vehicle's speed, acceleration, braking force, steering angle, RPM, gear status) related to a driving status of the moving vehicle, data (such as GPS coordinates, altitude, azimuth, etc.) related to the location of the moving vehicle, data (such as forward collision warning occurrence information, emergency braking system operation information, lane departure warning occurrence information) related to the operation of ADAS functions, data (such as airbag deployment information, moving vehicle collision detection information, rollover detection information) related to the safety of the moving vehicle, status information of the moving vehicle (such as engine status, tire pressure, fuel level, battery status, etc.), data (such as weather conditions, road conditions, illuminance, etc.) related to the surrounding environment, etc. Preferably, the moving vehicle data may include at least one of a speed, acceleration, forward collision warning information, emergency braking occurrence information, GPS data, moving vehicle collision information, and airbag collision detection information of the moving vehicle.

The moving vehicle data may be collected and utilized individually, or create new meaningful information by combining two or more pieces of data. For example, the GPS data and acceleration data may be combined to analyze the frequency of sudden braking on a specific road section. In addition, the moving vehicle data may be processed in real time to detect situations requiring immediate response, or data accumulated over a certain period of time may be analyzed to identify specific patterns or trends.

The moving vehicle data mentioned in the present disclosure is not limited to data that may be collected at the current technological level, and may include all types of moving vehicle-related data that may be newly collected, generated, and processed according to future technological developments. In addition, the data collection method, storage form, processing method, etc., are not limited to currently known methods, and may include all methods that may be developed in the future.

In the selecting (S110) of the accident prediction section, a section including moving vehicle data corresponding to preset abnormal data selection criteria a certain number of times or more may be selected as the accident prediction section. In the step (S110) of selecting the accident prediction section, the preset abnormal data selection criteria may be set in various ways depending on the characteristics of moving vehicle data. The abnormal data selection criteria may be set as a fixed threshold value, or may be applied variably according to various conditions such as time zone, season, and road type.

Examples of the abnormal data selection criteria related to the driving operation of the moving vehicle may include cases where longitudinal acceleration exceeds a certain value (e.g., −0.6 g), lateral acceleration exceeds a certain value (e.g., ±0.5 g), a change in steering angle exceeds a certain value (e.g., 100° per second), a rapid change (e.g., change in 50 km/h or more within 3 seconds) in driving speed, etc.

Examples of the abnormal data selection criteria related to the operation of the ADAS function may include cases where forward collision warning (FCW) occurs, autonomous emergency braking (AEB) is activated, lane departure warning (LDW) occurs, blind-spot collision warning occurs, etc. In addition, the case where such the ADAS warning or the control intervention occurs multiple times within a specific period of time or occurs simultaneously in multiple moving vehicles may be determined as abnormal data.

In the step (S110) of selecting the accident prediction section, the determination on the section where the abnormal data is included a certain number of times or more may be performed in various ways, and the ‘certain number of times’ may be set as an absolute number or as a relative standard. These criteria may be applied variably depending on various environmental factors such as a type of road (highway, city road, etc.), speed limit, traffic volume, and weather conditions, and may be applied by combining multiple criteria rather than a single criterion.

Examples of the absolute frequency criteria include a case where the sudden braking (longitudinal acceleration of −0.6 g or more) occurs 50 times or more in a specific section for one month, a case where the lane departure warning occurs 100 times or more for a week, or a case where the forward collision warning occurs 20 times or more for a day. Examples of the relative criteria include a case where the number of occurrences is twice or more the average number of occurrences in the section, a case where the number of occurrences is 1.5 times or more the average number of occurrences in other sections of the same road class, a case where the number of occurrences is 30% or more than the same month of the previous year, etc.

Different frequency criteria may be applied depending on the severity of each type of abnormal data. For example, in the case of data with high severity such as airbag deployment or moving vehicle collision, the criteria may be set to occur at least once a month, in the case of data with medium severity such as sudden braking or rapid evasive steering, the criteria may be set to occur at least 10 times a week, and in the case of relatively minor data such as lane departure warning, the criteria may be set to occur at least 20 times a day. Meanwhile, the range of the section may be set based on a fixed distance such as 100 m, 500 m, or 1 km, or may be set based on coordinates such as within a radius of 50 m centered on a specific GPS coordinate, or may be set based on road structure such as from the start point to the end point of an intersection or curve section, or may be set based on administrative districts such as a specific section of a specific road.

The step (S110) of selecting the accident prediction section may include matching the selected accident prediction section to the navigation map installed in the moving vehicle. The step (S110) of selecting the accident prediction section may update the navigation so that the matched map is reflected to the driver moving vehicle.

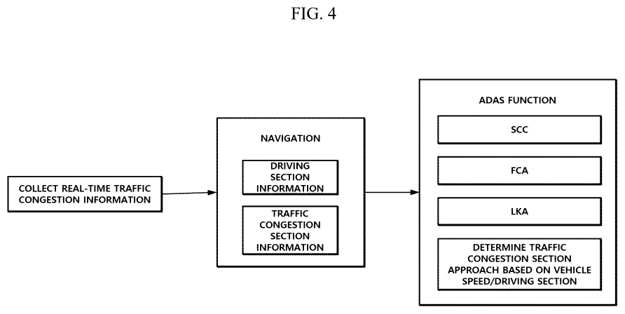

FIG. 4 is a flowchart of a step (S130) of receiving the real-time traffic congestion section information according to an embodiment of the present disclosure. Referring to FIG. 4, the step (S130) of receiving the real-time traffic congestion section information may receive the real-time traffic congestion section information.

In the step (S130) of receiving the real-time traffic congestion section information, the driving section information currently being driven is received, and the driving section information may include the real-time traffic congestion section information.

The real-time traffic congestion section information mentioned in the present disclosure may mean the information on the section where the driving speed of the moving vehicle is significantly reduced compared to a normal traffic condition or the information on the section where stopping and moving are repeated. The real-time traffic congestion section information may be received in real time through a navigation system, and may be generated based on data from various sources such as data collected from moving vehicles on the road, traffic information collected from various monitoring devices installed on the road, and information provided from a traffic control system.

The real-time traffic congestion section information may include the degree of congestion (average speed of moving vehicles, length of congestion, etc.), location information (GPS coordinates of the starting point and the ending point, road name, mileage, etc.) of the traffic congestion section, cause (accident, construction, concentrated traffic volume, etc.) of congestion, expected time required, detour information, etc. The real-time traffic congestion section information may also include the real-time change in traffic congestion conditions (expansion or reduction of the traffic congestion section, changes in the degree of congestion, etc.).

The ‘driving section information’ means information on the section in which the moving vehicle is currently driving or is scheduled to drive, and may include all types of road and traffic-related information provided by the navigation system. Specifically, the driving section information may include the type (highway, national road, city road, etc.) of road, the number of lanes, speed limit, road shape (straight, curved, uphill, downhill, etc.), intersection or junction information, major structure information such as tunnels or bridges, auxiliary facility information such as rest areas for drowsy drivers, construction section information, accident-prone section information, speeding enforcement section information, etc.

Such real-time traffic congestion section information and driving section information may be processed individually or in conjunction with each other. For example, the ADAS setting values may be adjusted by comprehensively considering the road characteristics (tunnels, construction sections, etc.) and congestion conditions of the driving section. In addition, such information is not limited to information that may be provided at the current level of technology, and may include all types of road and traffic-related information that may be newly added or subdivided according to future technological developments.

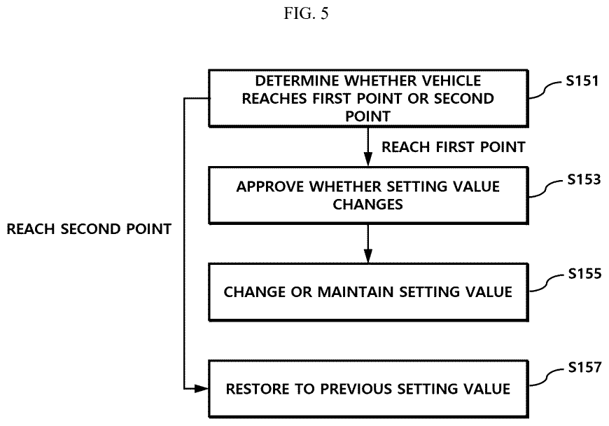

FIG. 5 is a flowchart of a step (S150) of changing a setting value according to an embodiment of the present disclosure. Referring to FIG. 5, the changing step (S150) may include a determination step (S151), an approval step (S153), a changing or maintaining step (S155), and a restoring step (S157).

The changing step (S150) may change the setting value of the ADAS to the preset setting value before entering the accident prediction section or traffic congestion section.

In the determination step (S151), it may be determined whether the moving vehicle reaches a first point that is a predetermined distance ahead of the accident prediction section or a traffic congestion section start point and a second point that is a predetermined distance away from the accident prediction section or a traffic congestion section end point, by using the driving section information received from the navigation and a current speed of the moving vehicle. In the determination step (S151), it may be determined whether it is the accident prediction section or the traffic congestion section by using the accident prediction section or the real-time traffic congestion section information matched to the navigation map.

The method of determining the first point and the second point by using the driving section information and the current speed of the moving vehicle in the determination step (S151) may be implemented in various ways. For example, the determination step (S151) may set the first point to a point 500 m prior to the accident prediction section start point when the current speed of the moving vehicle is 100 km/h, considering the braking distance required to stop and the driver's perception and reaction time, and may set the first point to a point 300 m prior when the current speed of the moving vehicle is 60 km/h. This is because, when driving at high speeds, it is necessary to prepare in advance at a longer distance, and when driving at low speeds, sufficient response is possible even at a relatively shorter distance.

In addition, the determination step (S151) may also consider the characteristics of the driving section when determining the first and second points. For example, the determination step (S151) may set the first point further away in a section with a high speed limit, such as a highway, and may set the first point relatively closer in a section with a low speed limit, such as an urban section. Similarly, the determination step (S151) may set the first point further away in a section that requires special attention, such as a curve section or a merging section, to secure sufficient preparation time.

In the determination step (S151), the second point may be set in a similar manner by considering the current speed and the characteristics of the driving section. For example, when driving at high speeds, the second point may be set further away from the accident prediction section or the traffic congestion section end point, and the ADAS setting may be restored after sufficiently confirming that the section has been completely passed.

The determination step (S151) may dynamically determine the first and second points based on the current speed of the moving vehicle and the characteristics of the driving section, rather than a fixed distance, thereby more effectively and safely changing the ADAS setting value.

In the approval step (S153), when the moving vehicle reaches the first point, the driver may be prompted to approve whether to change the setting value of the ADAS to the preset set value.

In an embodiment, in the approval step (S153), when the moving vehicle reaches the first point, the driver may be requested to approve the change of the ADAS setting value, and the approval request may be made through a visual notification via a display, an auditory notification via a warning sound, or a combination thereof. For example, a message such as “Do you want to activate an accident prediction/traffic congestion section safe driving service?” may be displayed, and the driver may approve or reject the message through a button on the steering wheel or a touch screen, etc.

In another embodiment, the safety driving assistance method according to the present disclosure may provide a function that allows a driver to set a preference for automatic change of ADAS setting value in advance. For example, the driver may activate or deactivate the option “Automatic change of ADAS settings when entering accident prediction section/traffic congestion section” in the system setting menu. When this option is activated, the ADAS setting value is automatically changed without a separate approval process when the moving vehicle reaches the first point. This may improve the convenience of the driver and prevent the loss of driving concentration due to frequent approval requests.

In another embodiment, such automatic change settings may be set in detail according to the situation. For example, various conditions may be set according to the driver's preference, such as activating automatic change for the accident prediction section and deactivating the automatic change for the traffic congestion section, or activating automatic change only on the highway. Such settings may be stored in conjunction with the driver profile, and the driver's preference settings may be automatically applied when the moving vehicle starts.

In another embodiment, the safety driving assistance method according to the present disclosure may provide a function that sets the on/off of the service itself. In other words, the driver may completely activate or deactivate the ‘safe driving assistance service’ function itself in the system settings menu. When this function is deactivated, no notification or automatic change related to the change in the ADAS setting value will occur even when entering the accident prediction section or traffic congestion section. On the other hand, when this function is activated, the change in the ADAS setting value will occur according to the various settings (whether to change automatically, situation-specific segmentation, etc.) described above. This overall service on/off setting may also be stored in conjunction with the driver profile, which provides the driver with complete autonomy to control whether to use the service depending on the situation and preference.

In the changing and maintaining step (S155), when the driver approves the change of the setting value of the ADAS, changing the setting value of the ADAS to the preset setting value, and when the driver does not approve the change of the setting value of the ADAS, maintaining a current setting value. The changing or maintaining step (S155) may be omitted when the above-described automatic change setting is activated.

In the restoring step (S157), when the moving vehicle reaches the second point, the setting value of the ADAS may be restored to the setting value before it is changed.

The setting value of the ADAS may be a setting value related to at least one of smart cruise control (SCC), forward collision-avoidance assist (FCA), and lane keeping assist (LKA).

In an embodiment, in the changing step (S150), upon entering the accident prediction section, the most conservative safety settings may be applied overall. In the case of the smart cruise control (SCC), the distance from the preceding moving vehicle is set to the maximum level 4 among levels 1 to 4 to secure sufficient braking distance, and the forward collision avoidance assist (FCA) function may set the warning time to ‘normal’ among ‘normal/slow’ to enable faster risk detection and response. In the case of the lane departure prevention assist (LKA) function, the allowable range of departure from the center of the lane is minimized to reinforce the driving in the center of the lane or set to the value that may advance the warning time as much as possible to enable faster risk detection and response.

In an embodiment, the changing step (S150) may apply a setting optimized for a low-speed driving environment when entering the traffic congestion section. The SCC may maintain an appropriate inter-vehicle distance by setting the distance from the preceding moving vehicle to level 3 or higher among levels 1 to 4, and the FCA may be set to have a high warning sensitivity so that it may sensitively detect collision risks even in low-speed driving situations. The LKA may be kept activated so that lane keeping assistance may be continuously provided even during low-speed driving.

In an embodiment, the changing step (S150) may apply differentiated settings according to the characteristics of the driving section. The changing step (S150) may strengthen the steering assistance of the LKA and automatically reduce the driving speed of the SCC in the curve section to enable the safe turning, and may quickly set the warning time of the FCA and increase the inter-vehicle distance of the SCC in the tunnel section to secure safety in the situation where the field of vision is limited. In the merging section, the warning sensitivity of the blind-spot collision avoidance assist function may be adjusted upward to minimize the risk of collision between the moving vehicles.

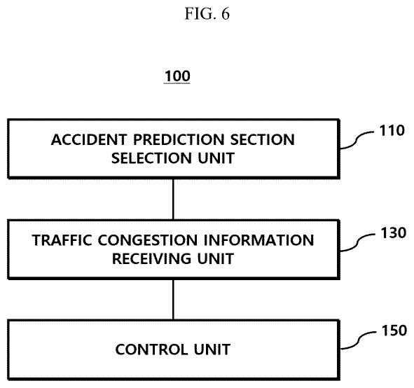

FIG. 6 is a flowchart of the safety driving assistance system 100 according to an embodiment of the present disclosure. Referring to FIG. 6, the safety driving assistance system 100 may include an accident prediction section selection unit 110, a traffic congestion information receiving unit 130, and a control unit 150.

The accident prediction section selection unit 110 may analyze moving vehicle data collected from a moving vehicle to select an accident prediction section. The accident prediction section selection unit 110 may perform the step (S110) of selecting the above-described accident prediction section.

The traffic congestion information receiving unit 130 may receive the real-time traffic congestion section information. The traffic congestion information receiving unit 130 may perform the step (S130) of receiving the aforementioned real-time traffic congestion section information.

The control unit 150 may change the setting value of the ADAS before entering the accident prediction section or traffic congestion section to the preset setting value. The control unit 150 may perform the above-described changing step (S150).

According to the present disclosure, by automatically changing the setting value of the ADAS function to the safer value before entering the accident prediction section and the traffic congestion section, it is possible to prepare for the dangerous situations without the active intervention of the driver.

In addition, according to the present disclosure, it is possible to prevent the driver from reducing his/her driving concentration by eliminating the inconvenience of having to change the ADAS setting directly while driving, and thus, enhance the accident prevention effect.

In addition, according to the present disclosure, by linking the accident prediction section information derived by analyzing the accumulated data of the moving vehicle and the real-time traffic congestion section information of the navigation with the ADAS, it is possible to assist the data-based safe driving.

Although the representative embodiments of the present disclosure have been disclosed for illustrative purposes, those skilled in the art will appreciate that various modifications, additions and substitutions are possible, without departing from the scope and spirit of the present disclosure as disclosed in the accompanying claims. Therefore, the scope of the rights of the present disclosure should not be limited to the described embodiments, but should be determined by all changes or modifications derived from the claims as well as the equivalent concepts of the claims.

What is claimed is:

1. A safety driving assistance method performed by a processor, comprising:
selecting an accident prediction section by analyzing moving vehicle data collected and accumulated from a moving vehicle;
receiving real-time traffic congestion section information; and
changing a setting value of an advanced driver assistance system (ADAS) before entering the accident prediction section or the real-time traffic congestion section to a preset setting value.

2. The safety driving assistance method of claim 1, wherein the moving vehicle data includes at least one of a speed, acceleration, forward collision warning information, emergency braking occurrence information, location information, moving vehicle collision information, and airbag collision detection information of the moving vehicle.

3. The safety driving assistance method of claim 2, wherein, in the selecting of the accident prediction section, a section including moving vehicle data corresponding to a preset abnormal data selection criterion a certain number of times or more is selected as the accident prediction section.

4. The safety driving assistance method of claim 1, wherein, in the selecting of the accident prediction section, a selected accident prediction section matches a navigation map installed in the moving vehicle.

5. The safety driving assistance method of claim 1, wherein, in the receiving of the real-time traffic congestion section information, information on a currently driving section is received, and driving section information includes the real-time traffic congestion section information.

6. The safety driving assistance method of claim 1, wherein the changing includes determining whether the moving vehicle reaches a first point that is a predetermined distance ahead of the accident prediction section or a traffic congestion section start point and a second point that is a predetermined distance away from the accident prediction section or a traffic congestion section end point, by using driving section information received from a navigation and a current speed of the moving vehicle.

7. The safety driving assistance method of claim 6, wherein the changing includes:
when the moving vehicle reaches the first point, receiving approval from a driver to change the setting value of the ADAS to a preset setting value; and
when the driver approves the change of the setting value of the ADAS, changing the setting value of the ADAS to the preset setting value, and when the driver does not approve the change of the setting value of the ADAS, maintaining an current setting value.

8. The safety driving assistance method of claim 7, wherein the changing includes, when the moving vehicle reaches the second point, restoring the setting value of the ADAS to a setting value before the setting value of the ADAS is changed.

9. The safety driving assistance method of claim 1, wherein the setting value of the ADAS is a setting value for at least one of smart cruise control (SCC), forward collision-avoidance assist (FCA), and lane keeping assist (LKA).

10. A safety driving assistance system, comprising:
an accident prediction section selection unit that analyzes moving vehicle data collected from a moving vehicle to select an accident prediction section;
a traffic congestion information receiving unit that receives real-time traffic congestion section information; and
a control unit that changes a setting value of an advanced driver assistance system (ADAS) before entering the accident prediction section or the real-time traffic congestion section to a preset setting value.
